(19) United States
(12) Patent Application Publication
(10) Pub. No.: US 2024/0337559 A1
(43) Pub. Date: Oct. 10, 2024

(54) DEVICE AND METHOD FOR CONVEYING AND LIVE CONTROLLING OF LIGHT BEAMS

(71) Applicants: CENTRE NATIONAL DE LA RECHERCHE SCIENTIFIQUE, PARIS (FR); UNIVERSITE DE LILLE, LILLE (FR)

(72) Inventors: Esben Ravn ANDRESEN, LILLE (FR); Jean YAMMINE, LAMBERSART (FR)

(73) Assignees: CENTRE NATIONAL DE LA RECHERCHE SCIENTIFIQUE, PARIS (FR); UNIVERSITE DE LILLE, LILLE (FR)

(21) Appl. No.: 18/699,093

(22) PCT Filed: Oct. 7, 2022
(86) PCT No.: PCT/FR2022/051897

§ 371 Date: Apr. 5, 2024

(30) Foreign Application Priority Data
Oct. 7, 2021 (FR) FR2110638

(51) Int. Cl. G01M 11/00

(52) U.S. Cl. CPC G01M 11/3145; G01M 11/3154; G01M 11/333

(57) ABSTRACT

Devices and methods for conveying and controlling light beams, in particular for endomicroscopic imaging referred to as “lensless”. The devices and methods apply for example to endoscopic exploration, for example of organs of a living being even when the living being is able to move about freely during the measurement. More particularly, the devices and methods allow measurement of the transmission matrix of an optical fiber while “live”, even though the fiber may undergo changes in configuration.

### FIELD

This invention relates to devices and methods for conveying and controlling light beams, in particular for endomicroscopic imaging referred to as “lensless”. This invention applies for example to endoscopic exploration, for example of organs of a living being even when this living being is moving about freely during the measurement.

More particularly, this invention allows measurement of the transmission matrix of an optical fiber while “live”, even though the fiber may undergo changes in configuration. This invention also relates to a fiber optic device suitable for implementing the method.

### BACKGROUND

Developments in endomicroscopic imaging require the use of fiber-based optomechanical devices which have specific characteristics in comparison to free-space imaging systems.

Indeed, the construction of a miniature microscope which would comprise a light source, focusing optics, and a camera at the distal end (meaning the end of the fiber intended for measurement, at the sample-oriented side) of a medical endoscope is not possible due to the bulk and obstructive properties of all the components. Solutions are therefore being sought which allow capturing an image of a sample using an optical fiber while reducing the bulk and obstructive properties at the distal end of the fiber.

“Lensless endoscopy” technology is known, which reduces the bulk and obstructive properties of the endoscope at its distal end.

Such technology has been described for example in Cizmar et al., “Exploiting multi-mode waveguides for pure fibre-based imaging”, Nat. Common. 3, 1027 (2012). This technique is based on the use of multi-mode optical fiber (or the abbreviation MMF). Multi-mode optical fiber is illuminated on its proximal side by a source of coherent light (the terms “proximal” and “distal” are defined as follows: the proximal side is the side closest to the source and furthest from the area to be analyzed, and the distal side is the side furthest from the source and therefore closest to the area to be analyzed). A wavefront modulator, also known as a spatial light modulator which is abbreviated as SLM, placed on the proximal side of the fiber, makes it possible to shape the field coming from the source and thus control the field injected into the multi-mode optical fiber. In other words, the wavefront modulator allows controlling at what amplitude and phase the propagation modes of the fiber are excited, so that the coherent addition of these modes allows generating the desired intensity profile at the distal end of the multi-mode optical fiber, typically a focus spot (also called a focus).

For example, it is possible to produce a focus at the distal end of the multi-mode optical fiber and scan the sample with said focus spot. The sample scan area then defines the area of the sample that will be imaged by analyzing the reflected light, backscattered light, or fluorescence emitted by that sample.

This technique, extremely powerful due to the deterministic nature of the fiber transmission matrix which connects an incoming field at the proximal part of the fiber with an outgoing field at the distal part (and vice versa), makes it possible to do without any optics at the distal side of the multi-mode optical fiber and therefore reduces the bulk.

However, the transmission matrix of the fiber is strongly dependent on the geometric configuration of the fiber. Endomicroscopic imaging using a multi-mode optical fiber is therefore extremely sensitive to fiber movements. Furthermore, because the optical fiber used is generally a multi-mode fiber, a short pulse close to the proximal end is elongated as it approaches the distal end, which limits the possibilities for applications in non-linear imaging which require working with short light pulses of high peak intensity.

In parallel with technologies based on the use of multi-mode fibers, a technology that is also “lensless” has been developed which uses a bundle of single-mode optical fibers or multi-core fibers abbreviated as MCF (see for example French et al. U.S. Pat. No. 8,585,587). In U.S. Pat. No. 8,585,587, a wavefront modulator (SLM) arranged on the proximal side of the bundle of single-mode optical fibers allows controlling, at the distal end of the bundle of fibers, the wavefront emitted by a light source. The single-mode nature of the fibers eliminates any intermodal dispersion. The only contribution to dispersion, and therefore to elongation of a short pulse, is chromatic dispersion which is the same for all single-mode optical fibers and which can therefore be compensated for globally. Therefore, the use of a bundle of single-mode optical fibers is preferred over multi-mode fibers for the propagation of short pulses (see nonlinear optics).

Other publications have described lensless endoscope variants based on the use of a bundle of single-mode optical fibers. These publications describe the use of a bundle of single-mode fibers. It has been shown that it is possible to access, in the distal part of the fiber, a very rapid scanning of the focus spot by applying a variable angle of the wavefront at the input to the wavefront modulator by means of a galvanometric device (see for example E. R. Andresen et al. “Toward endoscopes with no distal optics: video-rate scanning microscopy through a fiber bundle”, Opt. Lett. Vol. 38, No. 5, 609-611 (2013)).

In E. R. Andresen et al. (“Two-photon lensless endoscope”, Opt. Express 21, No. 18, 20713-20721 (2013)), the authors demonstrated the experimental feasibility of a two-photon nonlinear imaging system (TPEF, “two-photon excited fluorescence”) in lensless endomicroscopy. In E. R. Andresen et al. (“Measurement and compensation of residual group delay in a multi-core fiber for lensless endoscopy”, JOSA B, Vol. 32, No. 6, 1221-1228 (2015)), a device is described for group delay control (or “GDC”) for conveying and controlling light pulses in a lensless endomicroscopic imaging system based on the use of a bundle of single-mode optical fibers.

FIG. 1A schematically illustrates a lensless endomicroscopic imaging system 100 using a multi-mode optical fiber MMF of the state of the art, guiding N eigenmodes. The imaging system generally comprises an emission channel with an emission source 10 for emitting an incident light beam, continuous or formed of pulses in the case of applications in non-linear imaging. Imaging system 100 further comprises a detection channel comprising an objective OBJ and a camera. The optical path of the detection channel is separated from the optical path of the emission channel by a plate beamsplitter 22. Imaging system 100 also comprises a device for conveying and controlling the light beams which comprises multi-mode optical fiber MMF, and which makes it possible to illuminate a distant object to be analyzed 101, and a wavefront modulator SLM which is arranged at the proximal end of multi-mode optical fiber MMF and which makes it possible to control the wavefront (or the electromagnetic field which may simply be referred to as the “field”, characterized by an amplitude and a phase) of the beam emitted by source 10. Spatial light modulator SLM allows adjusting the phase function and the amplitude function of the wavefront of the incident beam, and thus controlling the phase function and the amplitude function of the wavefront of the beam exiting multi-mode optical fiber MMF.

FIG. 1B schematically illustrates a state of the art assembly which allows measuring the transmission matrix of a fiber.

The assembly in FIG. 1B is actually a simple modification of the lensless endomicroscopic imaging assembly of FIG. 1A. Some elements (a camera CAM, an objective OBJ) which have been added at the distal side increase the bulk of the device. By controlling fields injected at the proximal end of fiber MMF and measuring the resulting fields at the distal end of fiber MMF it is possible to calculate the transmission matrix of the fiber. By removing the objective (OBJ) and the camera (distal CAM), it is possible to image a sample placed at the distal end of the fiber according to a method known to those skilled in the art. However, as soon as fiber MMF changes configuration, it is necessary to redo the measurement, i.e. place the objective and camera back at the distal end of fiber MMF and redo the calculation of the transmission matrix of fiber MMF.

FIG. 1C schematically illustrates the injection of focus spots into a fiber and the measurement of the resulting field in order to calculate the transmission matrix in the localized mode basis of the fiber in any configuration, a basis of proximal localized modes being generated using a spatial light modulator SLM.

For each proximal localized mode, the following operation is carried out: a proximal localized mode is injected at the proximal end of fiber MMF (i.e. a light beam is injected at the proximal end of the fiber so as to obtain a focus spot at this location) and camera CAM measures the resulting field at the distal end of fiber MMF. The transmission matrix, in the localized mode basis, can thus be calculated from measuring the fields resulting from injection of the proximal localized modes.

“Localized modes” have amplitude profiles which spatially do not overlap or only slightly overlap. “Distal localized modes” may often be identified as pixels or groups of pixels measured by camera CAM. “Proximal localized modes” may often be identified as pixels or groups of pixels generated by spatial light modulator SLM.

The state of the art method for measuring the transmission matrix requires that the fiber remain in the same configuration during measurement of the transmission matrix (FIGS. 1B and 1C) and during the acquisition of images coming from the object to be analyzed (FIG. 1A).

To measure the transmission matrix in the localized mode basis, the number of proximal localized modes and the number of distal localized modes must both be greater than the number of eigenmodes guided by the fiber. The number of proximal localized modes does not necessarily have to be equal to the number of distal localized modes. This measurement method is time-consuming and highly sensitive to fiber configuration. For the measurement to be reliable, it is essential that the fiber not change its configuration for the entire duration of the measurement.

FIG. 1D illustrates the impact of a change in configuration from a known configuration REF to an unknown configuration RAND of the fiber. This change in configuration leads to a blurred image of the image acquired by lensless endoscopic imaging. Indeed, when the endoscope fiber is a multi-mode optical fiber MMF, the resulting image is blurry. And when the endoscope fiber is a multi-core fiber MCF, the resulting image is translationally shifted.

This interference appears because the change in configuration of the fiber disrupts the eigenmodes of said fiber. The transmission matrix of the fiber is then modified.

The blurring of the image due to the change in configuration of the fiber is particularly annoying during observations in vivo, for example of an organ. This results in a blurring of the captured image each time the configuration of the fiber deviates from the configuration in which the transmission matrix was measured.

In vivo imaging of a living being that is free to move is then impossible with the state of the art measurement method. A method for measuring fiber transmission matrices that is faster and easier to implement, allowing freedom of movement for the object to be analyzed, would therefore be a considerable advantage.

### SUMMARY

This invention improves the situation by proposing devices and methods for conveying and controlling light beams, in particular for endomicroscopic imaging systems referred to as “lensless”, which allow real-time measurement of the transmission matrix of the fiber in any configuration. In particular, the imaging method of this invention allows calculating the transmission matrix of a fiber in any configuration in real time, just before adjusting a wavefront modulator in real time during acquisition of an image or a batch of images of an object to be analyzed, such that imaging the object to be analyzed is possible even if the object is moving. The measured image is always sharp regardless of the fiber's configuration.

This invention is of particular interest in biology where it is sometimes necessary to obtain images in real time, for example of the brain of a mouse, even though the imaged sample is moving about and the endoscope along with it.

Thus, according to a first aspect, the invention proposes a method for measuring a transmission matrix of a first optical fiber, such as a multi-mode fiber, the optical fiber being in any configuration and guiding N eigenmodes, the fiber comprising a proximal section comprising a proximal end and a distal end and a distal section comprising a proximal end and a distal end, wherein the distal end of the proximal section is connected to the proximal end of the distal section by means of a fiber-to-fiber coupler, the method comprising the following steps:
separately injecting n trial fields at the distal end of the proximal section of the fiber,
measuring, at the proximal end of the proximal section of the first optical fiber, the resulting field for each of the n injected trial fields,
estimating Hₑₛₜ, a transmission matrix expressed in the basis of the N eigenmodes of the optical fiber, based on the measurement of the resulting fields for the n injected trial fields.

Such a method allows estimating the transmission matrix of an optical fiber in any configuration. The transmission matrix is also obtained in a very short time, close to a millisecond. The very short measurement time for the transmission matrix has the direct consequence of being able to image a sample in real time using a lensless endoscope because it is possible to determine the transmission matrix before each measurement of the sample, the measurements required to determine the transmission matrix and analyze the sample being carried out in extremely close or even identical fiber configurations.

Furthermore, unlike the state of the art where injection of a large number of known fields is carried out at the proximal end of the fiber and the resulting fields are measured at the distal end, this invention involves injecting a few trial fields at the distal end and measuring the resulting fields at the proximal end. However, the means proposed by this invention for injecting trial fields at the distal end of the proximal section of the first optical fiber are less bulky than the means for measuring the resulting fields at the distal end of an optical fiber according to a conventional measurement method, which makes it possible to have the means for measuring the transmission matrix and for measuring the sample within the same endomicroscope.

### Injection of Trial Fields

For the purposes of this invention, trial fields are understood to mean fields which have known properties and which allow, based on measurements of the resulting fields in the distal part (if injected into the proximal part), or the resulting fields in the proximal part (if injected into the distal part), calculating the transmission matrix H of the first optical fiber in any configuration. n trial fields are injected at the distal end of the proximal section of the fiber, n being a positive integer. Each trial field may be expressed using a column vector E_{i,trial field} of dimensions [N×1], i being a positive integer between 1 and n, and N being a positive integer corresponding to the number of eigenmodes of the first fiber. A trial field is for example a focus spot, injected into the first fiber.

For the purposes of this invention, the expression “focus spot injected at a location” or, equivalently, “localized mode injected at a location” means that a light beam (i.e. an electromagnetic field) is injected at that location and in a manner so that there is a focus spot there.

The transmission matrix estimation of this invention comprises a step which consists of injecting n trial fields at the distal end of the proximal section of a first optical fiber.

Each of the n trial fields is injected alone into the fiber. Once the field resulting from injection of a trial field is measured, another trial field is injected, and so on. n resulting fields are therefore successively measured.

The step of injecting the n trial fields may further comprise a simultaneous injection of the n trial fields so that the relative phase between the n trial fields is measurable. n+1 resulting fields are then measured in this case.

The trial fields may be chosen to be coherent (coming from the same laser) with each other. This makes it possible to improve the reliability of the transmission matrix estimation.

Preferably, each eigenmode of the first fiber must have a non-zero spatial overlap with at least one trial field.

The number n of trial fields may be chosen to be greater than or equal to the largest number of mutually degenerate eigenmodes of the multi-mode fiber, the number of mutually degenerate eigenmodes having been previously measured or being known.

The greater the number of trial fields injected, the better the estimation of the transmission matrix. However, the injection of too large a number of trial fields and the measurement of the various resulting fields runs the risk of requiring more than a millisecond to implement the invention. Conversely, injecting a small number of trial fields, but sufficient to enable estimating the transmission matrix of the first fiber, will give a more approximate estimate of the transmission matrix but with the advantage of requiring a shorter computation time, in particular close to a millisecond. The user is therefore free to choose a compromise between a short measurement time and a better estimate of the transmission matrix.

Preferably, the number n of trial fields is chosen to be equal to the greatest number of mutually degenerate eigenmodes of the transmission matrix of the first fiber.

A trial field is generated using a light source. The light source may be coupled to an optical device such as an objective. The light source is for example a laser. The light source may advantageously be coupled to an objective and to a wavefront modulator SLM.

According to one exemplary embodiment, the trial fields may be injected using a second optical fiber such as a multi-core optical fiber, its distal end connected to the distal end of the proximal section of the first fiber for example between 1 mm and 5 cm, preferably 2 cm, upstream from the distal end of the distal section of the first optical fiber.

According to this example, the trial fields may be the eigenmodes of the second optical fiber.

According to this exemplary embodiment of this invention, the trial fields are injected at the proximal end of the second optical fiber, travel through the second optical fiber, emerge at the distal end of the second optical fiber, then are then injected at the distal end of the proximal section of the first optical fiber. The trial fields then travel through the proximal section of the first optical fiber and finally emerge at the proximal end of the first optical fiber (which is the proximal end of the proximal section) where the resulting fields may be measured in order to measure the transmission matrix of the first fiber throughout its length (proximal section and distal section). The connection between the first fiber and the second fiber will be explained in more detail below.

Because the trial fields are injected at the distal end of the proximal section of the first fiber and not at the distal end of the distal section of the first fiber as in the methods of the prior art, the method of this invention may be implemented without the need for restrictive optics placed at the distal end of the first optical fiber (which is the distal end of the distal section). The distal end of the first optical fiber being without any optics, it is possible for the distal end of the first fiber to easily approach a small biological sample. For example, the distal end of the distal section of the first fiber may be inserted into the head of a living mouse in order to image an area of its brain.

The second optical fiber is preferably a multi-core fiber with single-mode cores. The multi-core optical fiber may comprise at least as many cores as there are trial fields, each trial field being conveyed in a dedicated core of the multi-core optical fiber before being injected at the distal end of the first fiber.

Single-mode optical fiber is understood to mean a fiber in which light can only propagate in a single mode of the electromagnetic field; by extension, an optical fiber referred to as “effective single mode” is understood to include several modes but the coupling conditions only excite a single mode (generally the fundamental mode) which confines the light throughout its propagation (no leakage to other modes).

Throughout the description, the term “single-mode optical fiber” may be used to refer to both an individual single-mode optical fiber and to a single-mode core of a multi-core optical fiber.

Conveying a trial field in a dedicated core of the multi-core optical fiber makes it possible to limit optical distortions undergone by the trial field along the fiber. Indeed, if the second fiber is a multi-mode fiber, the trial field may undergo different distortions, while in a single-mode core of a multi-core fiber the amplitude profile and the phase profile of the trial field remain unchanged, apart from an overall phase shift.

According to one or more aspects of this invention, each of the n trial fields may be modulated beforehand by means of a wavefront modulator (SLM), before being injected at the proximal end of the second optical fiber.

Such modulation of the trial fields makes it possible to compensate for the optical distortion, however minimal, undergone by the trial fields within the second fiber.

The wavefront modulator may comprise a segmented deformable mirror or a membrane mirror, for operation in reflection mode. The wavefront modulator may comprise a liquid crystal array, for operation in reflection or transmission mode.

### Measurement of the Resulting Fields

The method of this invention comprises a step which consists of estimating the transmission matrix of the first optical fiber, in any configuration, based on the measurement of the fields resulting from injection of n trial fields.

Field E_{i,result,field} resulting from the injection of trial field E_{i,trial field} may be measured using a camera, such as a CMOS or CCD sensor, the camera being placed at the proximal end of the proximal section of the first optical fiber. The proximal end of the proximal section of the first optical fiber may be coupled to a camera by means of an optical device such as an objective.

Measurement of a resulting field consists of measuring its phase function and amplitude function.

Measurement of the resulting field (at the proximal side of the first optical fiber) which results from injection of a trial field (at the distal end of the distal section or the distal end of the proximal section of the first optical fiber) may be carried out according to different polarization modes. Preferably, the resulting fields are measured according to two orthogonal polarization states.

Measurement of the resulting fields according to different polarization states makes it possible to improve the estimation of the transmission matrix.

### Estimation of the Transmission Matrix

The method of this invention comprises a step of estimating the transmission matrix of the first optical fiber based on the measurement of the resulting fields E_{i,resultfield}. This estimation step is advantageously carried out in a very short time, close to a millisecond. Thus, once the transmission matrix of the first optical fiber has been estimated, the first optical fiber can be used as a lensless endoscope to image a sample. As soon as the first optical fiber changes configuration again, for example during movement of the sample, its transmission matrix is re-estimated.

Any optical fiber may be characterized by a transmission matrix which ties an incoming field to an outgoing field. As an illustration, a focus spot injected at one end of an optical fiber may exit the opposite end of the fiber translated, attenuated, or even scrambled; in the latter case, the resulting field then forms a speckle. Knowledge of the transmission matrix of the optical fiber in any configuration makes it possible to anticipate the distortions that the configuration of the fiber will apply to the light beam traveling through it. However, the transmission matrix of an optical fiber depends on the geometric configuration of the fiber. The same optical fiber when straight or curved will not result in the same distortions in an incoming field, and will therefore not have the same transmission matrix.

In practice, the transmission matrix of an optical fiber is measured using a camera comprising a CCD or CMOS sensor. The following article gives an example of a method that seeks to determine the transmission matrix of a multi-mode fiber (see “Time-dependence of the transmission matrix of a specialty few-mode fiber” APL Photonics 4, 022904 (2019); https://doi.org/10.1063/1.5047578, J. Yammine, A. Tandjé, Michel Dossou, L. Bigot, and E. R. Andresen). The dimensions of the transmission matrix are then limited by the dimensions of the camera sensor. When measured, the fiber transmission matrix is conventionally expressed in its localized mode basis. A mathematical operation may allow expressing the transmission matrix of the optical fiber in its eigenmode basis.

According to one or more aspects of this invention, estimation of the transmission matrix in its eigenmode basis is carried out by means of an algorithm that makes use of a maximum likelihood method, the maximum likelihood method preferably being a least mean squares method. The algorithm thus makes it possible to give an estimate of the transmission matrix Hₑₛₜ of the fiber in any configuration.

The least mean squares method minimizes the function f defined according to the following equation [Math 1] by optimizing Hₑₛₜ:

$$f = \sum \sum {\vert {H}_{est} \cdot {E}_{trials} - {E}_{resultfields} \vert}^{2} \qquad [ Math . 1 ]$$

where E_{Trials} and E_{Resultfields} are matrices of dimensions [N×n] which respectively contain the n trial fields E_{i,trials} and the n resulting fields E_{i,resultfields}, N being the number of eigenmodes guided by the fiber.

The algorithm is thus configured to give the best estimate Hₑₛₜ of the transmission matrix of the fiber in any configuration.

Such an algorithm allows rapid calculation of and a satisfactory approach to the transmission matrix of the first fiber.

The method according to the invention may comprise a preliminary step of measuring the transmission matrix of the first optical fiber in a reference configuration in a localized mode basis, according to a method for measuring a transmission matrix known to those skilled in the art, as presented above, then a step of changing the basis of said transmission matrix into its eigenmode basis. In this case, the transmission matrix of the first fiber is measured for example in the proximal-distal direction (or in the distal-proximal direction) all along the first fiber.

Let H0_{proximal-distal} be the transmission matrix of an optical fiber in a reference configuration, measured in the proximal-distal direction. Transmission matrix H0_{distal-proximal} of the same fiber considered in the distal-proximal direction is obtained by transposing the above.

The procedure for estimating the transmission matrix of the first optical fiber throughout its length assumes that the trial fields are injected at the distal end of the distal section of the first optical fiber. However, the trial fields may be injected using a second optical fiber, at the distal end of the proximal section of the first fiber, i.e. at the fiber-to-fiber coupler placed 1 mm to 5 cm and preferably 2 cm upstream of the distal end of the distal section of the first optical fiber. In doing so, the trial fields are not injected at the distal end of the distal section of the first optical fiber, and the transmission matrix of the first optical fiber (proximal section and distal section) may be somewhat distorted.

This invention may overcome this problem by considering the virtual image of the trial fields injected at the distal end of the proximal section of the first fiber as if they were injected at the distal end of the distal section of the first fiber.

Indeed, knowing matrix H0_{proximal-distal}, it is possible to calculate the virtual image of the trial fields, according to the following equation: E_{trials,distal}=H0_{proximal-distal}. E_{resultfields,proximal}, where E_{trials,distal} corresponds to the field of the virtual image of the trial fields considered at the distal end of the distal section of the first optical fiber, H0_{proximal-distal} is the transmission matrix of the first optical fiber in a reference configuration, measured according to a method known to those skilled in the art, and E_{resultfields,proximal} indicates the fields resulting from injection of the trial fields via the second optical fiber through the fiber-to-fiber coupler, measured at the proximal end of the proximal section of the first fiber.

This preliminary step of measuring the transmission matrix of the first optical fiber concerned along its entire length (proximal section and distal section) therefore makes it possible to compensate for the fact that the trial fields cannot be injected directly at the distal end of the distal section of the first optical fiber but at the distal end of the proximal section of the first fiber, i.e. between 1 mm and 5 cm and preferably 2 cm upstream of the distal end of the distal section of the first optical fiber. The estimation of the transmission matrix of the first optical fiber obtained according to the method of this invention will therefore be even more precise.

Preferably, the trial fields considered in the maximum likelihood algorithm for estimating the transmission matrix of the first optical fiber are the virtual images of the trial fields injected via the second optical fiber.

### The First Optical Fiber

As the transmission matrix of the first optical fiber in a reference configuration has been determined, it is possible to store it so that prior calibration is not necessary for each implementation of the imaging method of this invention. This is why the first optical fiber which is the object of this invention may be characterized by its transmission matrix obtained in a reference configuration and expressed in its eigenmode basis.

According to another aspect, this invention relates to a first multi-mode optical fiber, the transmission matrix in a reference configuration of said fiber being known; the fiber comprising a proximal section having a proximal end and a distal end, and a distal section having a proximal end and a distal end, the fiber having a fiber-to-fiber coupler placed at least 5 cm upstream of its distal end, the fiber-to-fiber coupler being configured to receive the end of a second optical fiber, such as a multi-core fiber.

The first optical fiber is preferably a multi-mode optical fiber (MMF). The first fiber is for example a step-index or gradient-index fiber. The first optical fiber may be made of glass or plastic. Preferably it is made of glass.

Such a fiber makes it possible to easily and inexpensively manufacture an endoscope with minimal bulk on the distal side.

The function of the fiber-to-fiber coupler is to transfer part of the light beam exiting the distal end of the proximal section to the proximal end of the distal section. The fiber-to-fiber coupler is also intended to transfer part of the light beam coming from the proximal end of the distal section to the distal end of the proximal section. Finally, the fiber-to-fiber coupler is intended to transfer part of the light beam coming from the distal end of the second fiber to the distal end of the proximal section of the first fiber.

It is thus easier for the user to manipulate the first optical fiber and place it conveniently near the sample, without disturbing the sample (see the mouse brain example).

The fiber-to-fiber coupler may be placed at a distance between 1 mm and 5 cm, preferably 2 cm, from the distal end of the distal section of the first fiber. The distal section of the first fiber thus measures 1 mm to 5 cm.

The coupling between the proximal section and the distal section of the first fiber is preferably greater than 50% so as to obtain good use of the light coming from the source and traveling through the first optical fiber in the proximal-distal direction on the one hand, and of the light reflected by or backscattered by, or of the fluorescence emitted by, the sample traveling through the first optical fiber in the distal-proximal direction.

The coupling between the distal end of the second fiber and the distal end of the proximal section of the first fiber is preferably less than 50%.

The coupling between the cores of the second optical fiber is preferably less than −20 dB/m, so that the trial fields propagate independently within it.

To implement the fiber-to-fiber coupler, those skilled in the art may use a commercially available device or may create a fiber-to-fiber coupler themselves using known methods. For example, those skilled in the art may use a commercially available multi-mode coupler. Also, those skilled in the art may create the fiber-to-fiber coupler by means of an assembly of miniaturized free-space optics using commercially available lenses and plate beamsplitters or by creating the optics and plate beamsplitters by means of 3D printers. Finally, those skilled in the art may couple the fibers together by cutting their ends in a bevel, polishing the beveled faces, then connecting the ends of two fibers together; the cut and polished fibers are then called “functionalized fibers.”

The fiber-to-fiber coupler may also be made by a combination of the methods cited above. The first and second optical fiber may also refer to cores or groups of cores of a same optical fiber, in which case the fiber-to-fiber coupler should couple said cores in the same manner as in the case of separate optical fibers as described above.

The first optical fiber may have a length of a few centimeters to several meters. A long fiber has the advantage of allowing the mouse a lot of freedom of movement in the illustrative case where the imaged sample is a mouse brain. On the other hand, a long optical fiber easily changes its configuration. In contrast, a short fiber does not deviate much from its reference configuration, but it limits the movements of the mouse in the illustrative case already mentioned.

The diameter of the fiber may be between 50 μm and 1 mm.

### Device for Endoscopic Imaging

According to another aspect, this invention relates to a device for endomicroscopic imaging, comprising:
a light source for emitting light beams,
a first optical fiber as defined above for conveying and controlling light beams emitted by the light source, where the proximal section of the first fiber is in any configuration and is free to move,
optionally a second optical fiber, such as a multi-core fiber, having its distal end coupled by means of a fiber-to-fiber coupler as mentioned above to the distal end of the proximal section of the first optical fiber, the second fiber enabling the conveying of n trial fields to the distal end of the proximal section of the first fiber;
a detection channel configured for measuring the light signal reflected by the sample traveling through the distal section and proximal section of the first optical fiber.

Optionally, the proximal end of the second optical fiber is coupled to a wavefront modulator so that the trial fields, at the distal end of the second optical fiber, are known and can be modified.

The detection channel may comprise at least one wavefront modulator, an objective, and a camera. The detection channel may also comprise a sensor which allows detecting changes in the configuration of the proximal section of the first optical fiber. Such a sensor may be an accelerometer or a timer.

According to yet another aspect, this invention relates to a method for the endomicroscopic imaging of a sample, the method preferably being implemented using a device as described above, the method comprising the following steps:
estimating, according to the method of this invention, the transmission matrix of a first optical fiber in the eigenmode basis of the optical fiber, the fiber preferably being multi-mode,
calculating a phase mask as a function of the estimated transmission matrix and applying it sequentially to a wavefront modulator, in order to form an illuminating beam of known phase function at the distal end of the first optical fiber, for example a focus spot,
measuring the signal reflected from the focus spot by the sample and reconstructing an image of the sample,
repeating the step of estimating the transmission matrix after a predetermined period of time has elapsed or the fiber substantially changes configuration, for example based on data from an accelerometer or a timer.

Such a method for endoscopic imaging allows imaging a sample of microscopic size, limited by the diameter of the first optical fiber. The method is also reliable and fast.

According to a final aspect, the invention relates to a computer program comprising instructions for implementing the method of the invention when this program is executed by a processor.

Also, the invention relates to a non-transitory computer-readable storage medium on which is stored a program for implementing the method according to the invention when this program is executed by a processor.

### BRIEF DESCRIPTION OF DRAWINGS

Other features, details, and advantages of the invention will become apparent upon reading the detailed description below, and upon analyzing the appended drawings, in which:

FIG. 1A

FIG. 1A schematically illustrates a lensless endomicroscope imaging system using an optical fiber guiding N eigenmodes according to the prior art;

FIG. 1B

FIG. 1B schematically illustrates the assembly for measuring the transmission matrix according to the state of the art;

FIG. 1C

FIG. 1C schematically illustrates the method for measuring the transmission matrix according to the state of the art;

FIG. 1D

FIG. 1D illustrates the impact of a change in the configuration of the optical fiber, which results in a noisy image for the image acquired by lensless endoscopic imaging of the prior art;

FIG. 2

FIG. 2 illustrates a first multi-mode optical fiber in a reference configuration;

FIG. 3A

FIG. 3A illustrates a fiber-to-fiber coupler implemented via the assembly of functionalized optical fibers;

FIG. 3B

FIG. 3B illustrates another fiber-to-fiber coupler implemented via the assembly of functionalized optical fibers;

FIG. 3C

FIG. 3C illustrates a fiber-to-fiber coupler implemented via the assembly of miniaturized free-space optics;

FIG. 3D

FIG. 3D illustrates a multi-mode fiber coupler;

FIG. 4A

FIG. 4A illustrates a transmission matrix of the optical fiber in the localized mode basis,

FIG. 4B

FIG. 4B illustrates the same transmission matrix but expressed in the eigenmode basis of the optical fiber;

FIG. 5

FIG. 5 illustrates the scan of a focused beam exiting (distal end of the distal section) the first optical fiber in its reference configuration;

FIG. 6

FIG. 6 illustrates a multi-mode first optical fiber in any configuration that is different from its reference configuration;

FIG. 7

FIG. 7 illustrates an attempted scan by the beam exiting the multi-mode first fiber (distal end of the distal section) if the estimated transmission matrix corresponds to a configuration which differs from the actual configuration of the optical fiber;

FIG. 8

FIG. 8 illustrates an example of the injection of trial fields;

FIG. 9

FIG. 9 illustrates the measurement of fields resulting from the injection of trial fields, according to two orthogonal polarization states;

FIG. 10

FIG. 10 illustrates the comparison between an actual transmission matrix and a transmission matrix estimated according to the concept of this invention;

FIG. 11

FIG. 11 Scan of a focus using the estimated transmission matrix Hₑₛₜ;

FIG. 12

FIG. 12 is a diagram of a device for endoscopic imaging according to this invention, when the transmission matrix is measured in a reference configuration according to a method of the state of the art;

FIG. 13

FIG. 13 is a diagram of a device for endoscopic imaging according to this invention, where the transmission matrix Hₑₛₜ is estimated after measuring the fields resulting from the injection of trial fields;

FIG. 14

FIG. 14 is a diagram of the device according to the invention for acquiring an endomicroscopic image by scanning a sample.

### DETAILED DESCRIPTION

The drawings and the description below for the most part contain elements that are certain in nature. Therefore not only may they be used to provide a better understanding of the invention, but where appropriate they may also contribute to its definition. The reference OBJ is used in the figures to define an objective (or more generally an optical system); however, two objectives in the same figures do not necessarily have the same characteristics and are not necessarily identical. A person skilled in the art will know how to adapt each of the objectives according to their location in the optical path.

### The First Fiber and the Fiber-to-Fiber Coupler

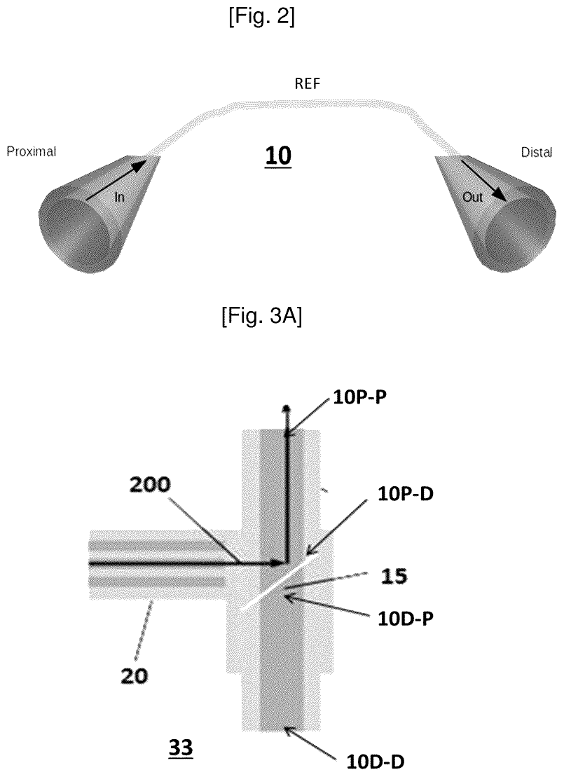

Reference is made to FIG. 2. FIG. 2 is a diagram of a first optical fiber 10 in a reference configuration (REF) guiding N eigenmodes. The first optical fiber is for example a multi-mode fiber such as a step-index or gradient-index fiber or a multi-core fiber. First fiber 10 comprises a distal end and a proximal end. The distal end is intended to be placed as close as possible to the sample to be imaged. The proximal end is intended to be connected to a detection channel and to an optical device such as a wavefront modulator injecting a field with known properties.

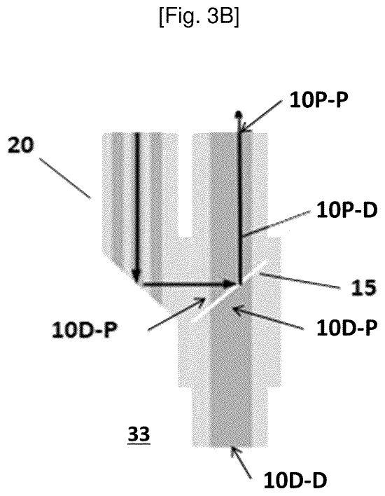

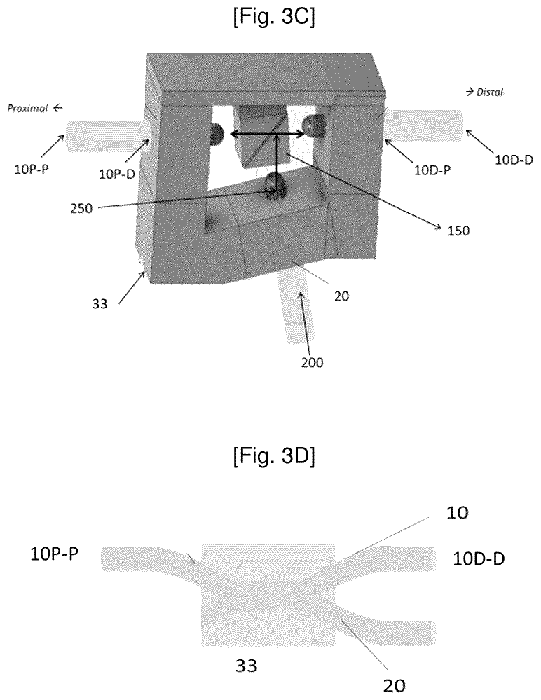

Reference is now made to FIGS. 3A, 3B, 3C, and 3D which show examples of a fiber-to-fiber coupler 33 according to this invention.

First fiber 10 may comprise two distinct sections 10D and 10P: a proximal section 10P comprising a proximal end 10P-P and a distal end 10P-D, where the proximal end is intended to be connected to a detection channel and to an optical device such as a wavefront modulator injecting a field with known properties; and a distal section 10D comprising a proximal end 10D-P and a distal end 10D-D, where distal end 10D-D is intended to be placed as close as possible to the sample to be imaged. The distal end of proximal section 10P-D and the proximal end of distal section 10D-P are connected by means of a fiber-to-fiber coupler 33.

### Functionalized Fiber-to-Fiber Coupler

FIGS. 3A and 3B illustrate two fiber-to-fiber couplers 33 which couple by functionalization of the fibers. This fiber-to-fiber coupler consists of bonding together the distal end of a second fiber 20, the distal end of the proximal section of first fiber 10P-D, and the proximal end of the distal section of first fiber 10D-P. The fiber-to-fiber coupler is placed at least 5 cm upstream from the distal end of first fiber 10D-D. The fiber-to-fiber coupler makes it possible to couple proximal section 10-P of the first fiber to a distal section 10D whose length can be adjusted.

Second fiber 20 is intended for conveying trial fields 200 towards the distal end of first fiber 10D-D. In FIG. 3A, the first fiber forms a right angle with the second. A surface in the first fiber allows redirecting the trial fields (by optical reflection) coming from the distal end of second fiber 20, towards the proximal end of first fiber 10P-P. In FIG. 3B, the two fibers are attached to each other; an air gap at the end of the second fiber then a surface 15 in the first fiber makes it possible to redirect trial fields 200.

The distal end of proximal section 10P-D and the proximal end of distal section 10D-P of first fiber 10 are cut at a bevel and are polished so that these ends are referred to as “functionalized”.

Fiber-to-Fiber Coupler which Couples by Assembling Free-Space Optics

Unlike integrated optics, fiber-to-fiber coupler 33 of the embodiment illustrated in FIG. 3C comprises a yoke, printed for example using a 3D printer. This yoke comprises a prism or a plate beamsplitter 150 which makes it possible to distribute the light rays between first 10 and second 20 optical fiber. The fiber-to-fiber coupler is placed at least 5 cm upstream from distal end 10D of first optical fiber 10. Fiber-to-fiber coupler 33 further comprises optics 250. Optics 250 are intended to focus the light rays in the various optical fibers. Trial fields 200 injected by means of second optical fiber 20 are redirected towards the proximal end of first fiber 10 by plate beamsplitter 150. As for the rays coming from the proximal end of first fiber 10, they are not deflected by plate beamsplitter 150 and continue their path towards the distal end of first fiber 10. Similarly, rays coming from distal end 10D of first fiber 10 continue their path towards the proximal end of first fiber 10 without being deflected by plate beamsplitter 150.

### Multi-Mode Coupler

FIG. 3D illustrates a multi-mode coupler 33 which allows connecting the distal end of a second fiber 20, for example a multi-core fiber, to a first fiber 10, for example a multi-mode fiber, so that trial fields injected at the proximal end of second fiber 20 are conveyed to the proximal end 10P-P of the first fiber. Then, the multi-mode connector allows fields injected at the proximal end of proximal section 10P-P of first fiber 10 to exit at the distal end of distal section 10D-D of said fiber, in order to create, for example, a focus on the sample to be analyzed.

### Estimating the Transmission Matrix of the First Optical Fiber

Let us consider a step-index multi-mode first fiber, the first fiber guiding for example N=30 eigenmodes.

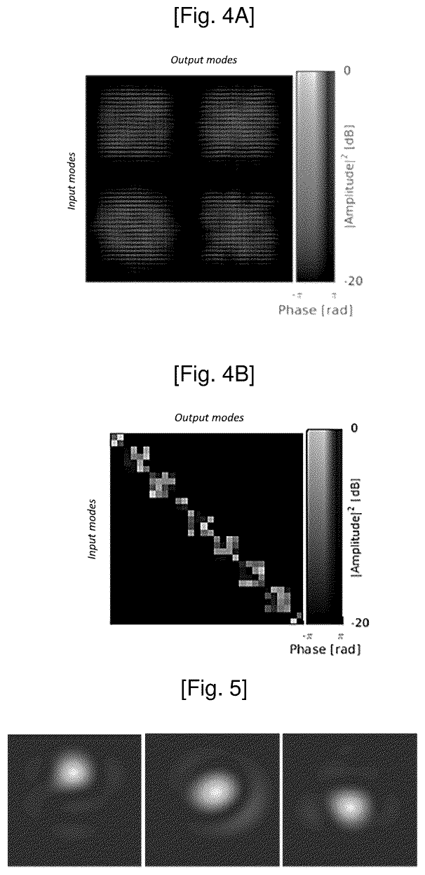

An example of a transmission matrix expressed in the localized mode basis is given in FIG. 4A. Once the transmission matrix in the localized mode basis has been measured, it can be expressed in its eigenmode basis via a change of basis operation. Such an operation may be carried out automatically using conventional computing software and a computer. FIG. 4B is an example of a transmission matrix expressed in the eigenmode basis of the fiber.

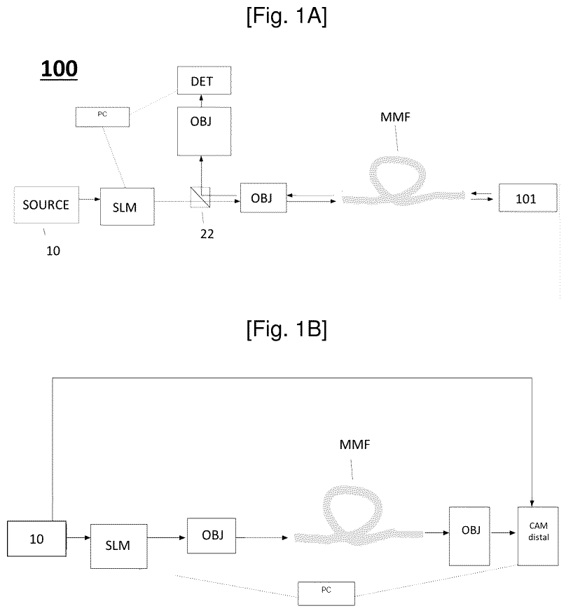

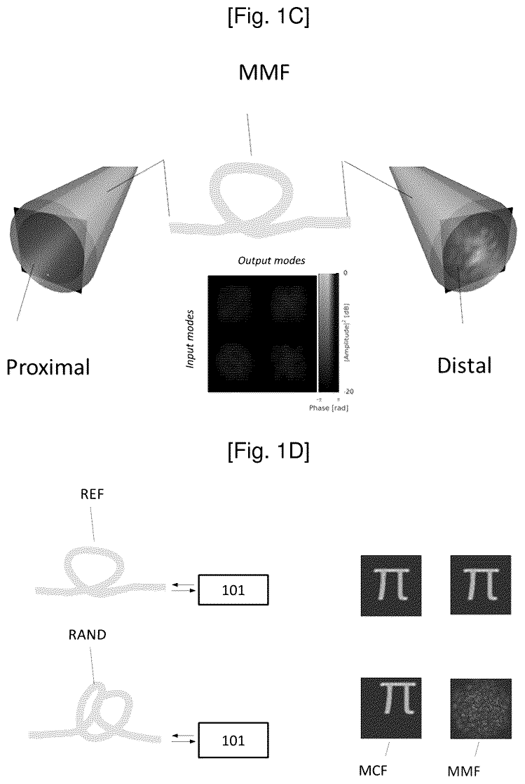

Transmission matrix H₀ of the fiber in a reference configuration may be obtained using a state of the art method, as illustrated in FIG. 1B. The publication “Time-dependence of the transmission matrix of a specialty few-mode fiber”, APL Photonics 4, 022904 (2019); J. Yammine, A. Tandje, Michel Dossou, L. Bigot, and E. R. Andresen, gives a method known to those skilled in the art for measuring the transmission matrix of the fiber in the proximal to distal direction.

Once the transmission matrix of the fiber is known, it is possible to perform the imaging by scanning the sample with a focused beam of light according to the principle of the lensless endoscope. This operation, however, requires that the fiber not change its configuration. Indeed, the transmission matrix of the fiber links an incoming field and an outgoing field according to the following equation: E_{outgoing}=H₀·E_{incoming} where E_{incoming} is a column vector in the basis of proximal localized modes containing a number of elements equal to the number of proximal localized modes and E_{outgoing} is a vector expressed in the basis of distal localized modes containing a number of elements equal to the number of distal localized modes.

Knowing transmission matrix H₀, it is therefore possible to ensure that E_{outgoing} corresponds to a focus spot E_{outgoing}=E_{focus,i} where E_{focus,i} is a null vector except at index i. To do so, one simply inverts the transmission matrix and injects, using a wavefront modulator, the following new incoming field: H₀⁻¹·E_{focus, i}.

FIG. 5 illustrates the scan of a focused beam exiting the distal end of the first fiber.

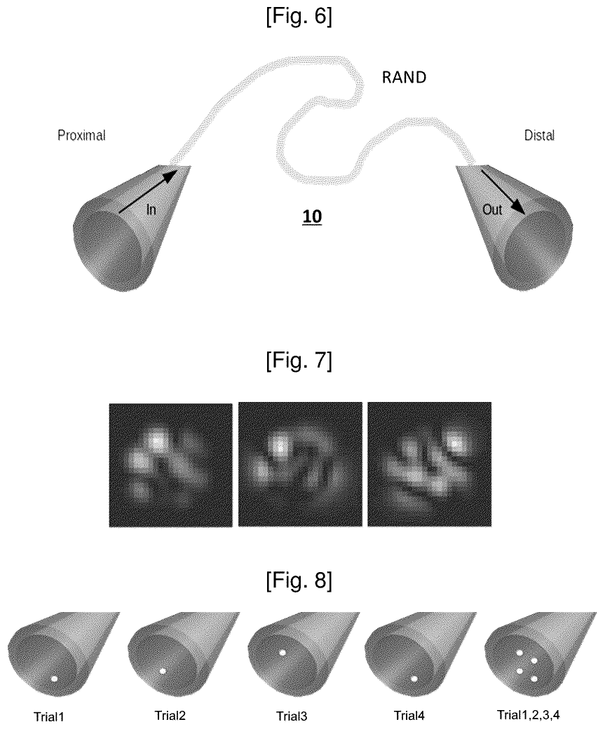

Reference is now made to FIG. 6. The first fiber is no longer in a reference configuration but is in any configuration.

Transmission matrix H of the optical fiber in a new configuration is different from transmission matrix H₀ of the optical fiber in its reference configuration. If we try to scan a focus spot according to the principle of the lensless endoscope, assuming that transmission matrix H of the optical fiber in any configuration is H₀, we are no longer able to scan a focus at the distal end of the optical fiber. In fact, the intensity profile at the output from the fiber is then a “speckle” and no longer a focused field.

FIG. 7 illustrates the speckle obtained in the case where the optical fiber changes configuration but the transmission matrix is not recalculated. To obtain a focus spot once again, it is necessary to remeasure the transmission matrix of the fiber.

Reference is now made to FIG. 8. To estimate the transmission matrix H of the fiber in any configuration, n trial fields are injected at the distal end of the fiber according to the method of this invention.

In FIG. 4B, one can see that transmission matrix H expressed in its eigenmode basis is a block diagonal matrix. It contains on its diagonal 2²+4²+4²+2²+4²+4²+4²+4²+2²=108 unknowns.

Each trial field, expressed in the same basis as H, represents N=30 knowns. Each trial field is in fact expressed by a vector comprising N=30 elements, where N=30 is the number of eigenmodes guided by the fiber. Thus, the injection of n=4 trial fields represents n×N=4×30=120 knowns.

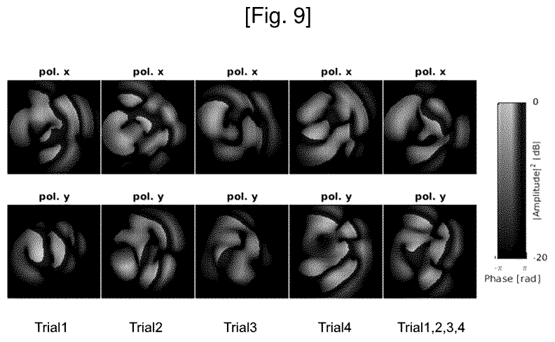

The fields resulting from injection of the trial fields (see FIG. 9), measured at the camera then expressed in the same basis as H, also represent n×N=4×30=120 knowns.

In theory, the number of knowns (120) being greater than the number of unknowns (108), it is possible to solve the system of linear equations which links the trial fields to the resulting fields in order to directly calculate transmission matrix H according to the following relation: E_{Resultfields}=H·E_{Trials} where E_{Trials} and E_{Resultfields} are matrices of dimensions [N×n]= [30×4] which respectively contain the four trial fields and the four resulting fields.

With reference to FIG. 8, the trial fields are for example the following:
Trial1: field focused on position1;
Trial2: field focused on position2;
Trial3: field focused on position3;
Trial4: field focused on position4.
   Note that positions 1, 2, 3, 4 are arbitrary to the extent that they are not identical.

According to the method of this invention, the trial fields are injected into the first fiber at its distal end. The resulting fields are measured at the proximal end of the first fiber by means of a camera for example. By default, the camera detects only the intensity (amplitude squared); in order to measure the field as well (i.e. the phase and amplitude), the camera is used with an interferometric method, for example the “off-axis holography” method.

FIG. 9 illustrates the five resulting fields, measured according to two orthogonal polarization states. From the fifth measurement, i.e. the superposition of the four trial fields, it is possible to extract the relative phases between the four trial fields.

To estimate transmission matrix Hₑₛₜ of the fiber in any configuration, a least mean squares algorithm is used according to this invention.

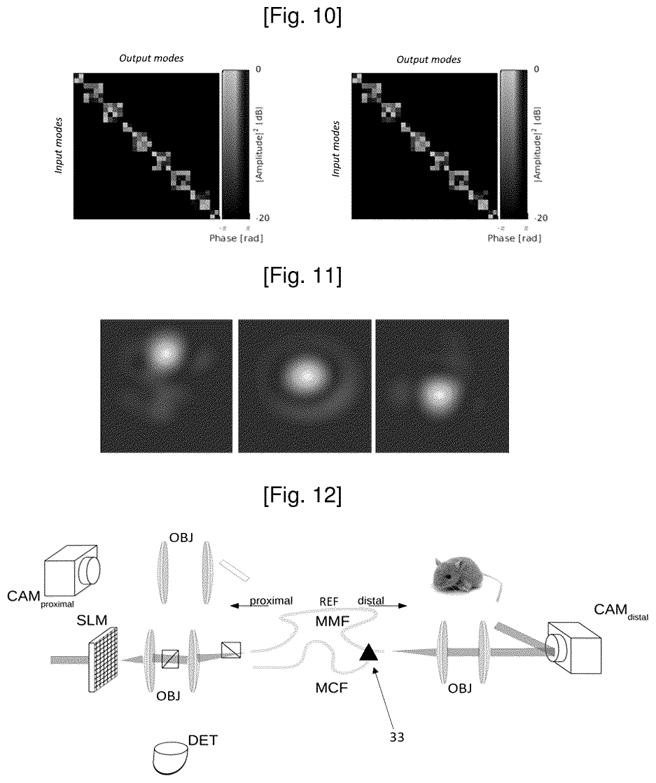

Reference is now made to FIG. 10. FIG. 10 illustrates two fiber transmission matrices in the same configuration. The left transmission matrix was measured according to a conventional method known to those skilled in the art, as discussed in the introduction to this description. The transmission matrix on the right was measured using a least mean squares algorithm which estimates the transmission matrix of the optical fiber based on the measurement of the resulting fields after the injection of four trial fields according to the example. FIG. 10 clearly demonstrates that the invention allows obtaining an excellent estimate of a transmission matrix of an optical fiber in a very short time.

The transmission matrix was therefore estimated with only five measurements. If the fiber guided a greater number of modes, five measurements would still have been sufficient to estimate H.

Considering a conventional multi-mode fiber guiding 1000 modes, methods of the state of the art would need at least 1000 measurements (and often much more in practice). The invention therefore makes it possible to divide the number of measurements by a factor of 200.

### Imaging Method

Once the transmission matrix of the first fiber has been estimated according to the method of this invention, it is possible to calculate a phase mask based on the estimated transmission matrix Hₑₛₜ and to apply it to a wavefront modulator in order to form an illuminating beam of known phase function at the distal end of the first optical fiber, for example a focus spot. FIG. 11 illustrates the scanning of a focus using the estimated transmission matrix for the fiber according to the method of this invention.

The imaging method according to this invention will now be described in more detail. FIGS. 12, 13, and 14 illustrate the same device for endoscopic imaging according to this invention, which allows implementing the method of this invention.

### The Device

The device for endoscopic imaging comprises a first optical fiber, preferably multi-mode MMF, comprising a proximal section and a distal section. First optical fiber MMF comprises a fiber-to-fiber coupler which connects said fiber to a second fiber, preferably multi-core MCF. The distal end of the distal section of the first fiber is without any optics. Thus, the distal end of the distal section of the first optical fiber may be placed as close as possible to a sample to be imaged. For example, the sample is the brain of a mouse, the mouse being alive and free to move about. The device according to the invention must be able to image the mouse brain in real time.

The device for imaging further comprises a camera CAM. The camera may be coupled with an objective OBJ. The camera and the objective allow measuring the resulting fields at the proximal end of the proximal section of first fiber MMF after the injection of trial fields through second fiber MCF.

The device also comprises a light source, not shown, for example a laser. The light source is advantageously connected to a wavefront modulator SLM. The wavefront modulator may also be coupled to an objective OBJ which allows injecting a controlled light signal at the proximal end of the proximal section of first optical fiber MMF.

A light distribution means is added after the wavefront modulator and the objective. This system is for example a mirror or a prism. The light distributor makes it possible either to direct the light coming from the wavefront modulator towards first optical fiber MMF or to direct the light beams reflected by the sample and passing through first optical fiber MMF towards a detection channel.

The detection channel for the light backscattered by the sample and transmitted through first fiber MMF from its distal end to its proximal end may comprise a sensor CAMₚᵣₒₓᵢₘₐₗ and optionally an objective OBJ for focusing the backscattered light onto a detection surface of the sensor, as well as a processing unit for processing the signals from the sensor.

### Preliminary Step—FIG. 12

Reference is now made to FIG. 12. FIG. 12 is a diagram showing the configuration of the device for endoscopic imaging which allows measuring the transmission matrix H0_{proximal-distal} of the first fiber in the proximal-distal direction according to one embodiment of the method of this invention, where a preliminary step of measuring the transmission matrix of first optical fiber MMF in a reference configuration (REF) in a localized mode basis is carried out.

In this configuration, the distal section of first optical fiber MMF is not yet connected to the sample. In this configuration, the detection channel comprising a camera CAM_{distal} with an objective OBJ is placed at the distal end of the distal section of first fiber MMF. This detection channel specific to the preliminary step of measuring the transmission matrix of the first fiber throughout its length may be the same detection channel which measures the resulting fields E_{resultfield} or a completely different detection channel.

The light source emits light beams which may be shaped by means of wavefront modulator SLM. These light beams travel through the first optical fiber along its entire length and are measured, at the distal end of the distal section of the first fiber, by means of the detection channel, at camera CAM_{distal}.

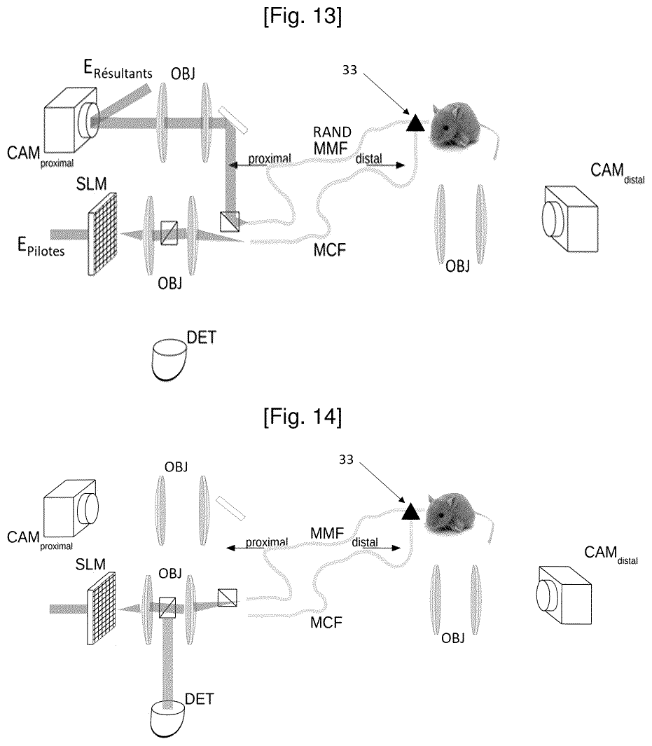

### Injection of Trial Fields—FIG. 13

Reference is now made to FIG. 13. FIG. 13 illustrates the measurement of the fields E_{Resultfields} resulting from injection of the trial fields E_{Trials} according to this invention. From this point on, the distal end of the distal section of the first optical fiber may be placed at the sample to be analyzed.

n trial fields E_{trials,lateral} are injected via second optical fiber MCF, and fiber-to-fiber connector device 33 redirects these trial fields towards first fiber MMF, at the distal end of the proximal section towards the proximal end of the proximal section of the first optical fiber.

The resulting fields E_{resultfields,proximal} at the proximal end of the proximal section of first optical fiber MMF are measured by means of a detection channel. This measurement may be carried out for two different polarization states, preferably orthogonal. In this case, camera CAM may be coupled for example to quarter-wave and/or half-wave plates.

The procedure for estimating the transmission matrix assumes that the trial fields are injected directly at the distal end of first fiber MMF and not at the distal end of the proximal section of the first fiber, meaning at the fiber-to-fiber coupler placed 1 mm to 5 cm upstream from the distal end of the distal section of the first fiber.

As already mentioned, it is possible to calculate the virtual image E_{trials,distal} that the trial fields E_{trials,lateral} injected at fiber-to-fiber coupler 33 would have at the distal end of the first optical fiber. To do so, it is necessary to consider transmission matrix H₀ of the optical fiber in a reference configuration, calculated in the preliminary step illustrated in FIG. 12.

E_{trials,distal}=H₀·E_{resultfields,proximal}

At this point, we know that injecting E_{trials,lateral} from the side is equivalent to injecting E_{trials,distal} from the distal end. The procedure for estimating the transmission matrix of the first fiber considered along its entire length (proximal section and distal section) now becomes possible, once it is assumed that it is E_{trials,distal} which are injected instead of E_{trials,lateral}.

Once the trial fields have been injected into first optical fiber MMF and the resulting fields measured at the proximal end of first optical fiber MMF by means of camera CAM, the method for estimating a transmission matrix of this invention makes it possible to estimate transmission matrix Hₑₛₜ of first optical fiber MMF in any configuration (RAND).

A least mean squares algorithm (or LMS) minimizes the function f defined according to the following equation Math. 2 by optimizing the estimated transmission matrix Hₑₛₜ:

$$f = \sum \sum {\vert {H}_{est} \cdot {E}_{trials} - {E}_{resultfields} \vert}^{2} \qquad [ Math . 2 ]$$

where E_{Trials} and E_{Resultfields} are matrices of dimensions [N×n] which respectively contain the n trial fields and the n resulting fields.

The algorithm finds the result Hₑₛₜ, the best estimate of H. The run time of the algorithm is approximately 1 ms on a standard computer.

### Sample Imaging—FIG. 14

Reference is now made to FIG. 14 where it is assumed that transmission matrix Hₑₛₜ of first optical fiber MMF in any configuration (RAND) has previously been measured using the method of this invention.

Knowing the transmission matrix of first fiber MMF, it is possible to calculate a phase mask with wavefront modulator SLM in order to output from first optical fiber MMF a controlled light beam, typically a focus spot.

The sample may then be imaged, for example by scanning the focus spot. The resulting image is measured pixel by pixel using the detection channel comprising a camera CAMₚᵣₒₓᵢₘₐₗ with an objective OBJ. The detection channel in the various steps of the imaging method according to this invention may be the same for each of the steps: in this case a conventional optical system which allows distributing the various light beams coming from the different ends of the optical fibers (MMF and MCF) is used. Otherwise, the various objectives OBJ specific to each of the detection channels may be different.

Each time the fiber changes configuration, the injection of the trial fields and the estimation of the new transmission matrix of the fiber is carried out. The estimation of the transmission matrix may also be carried out at a predetermined frequency. For example, the estimation of the transmission matrix may be carried out once per second, twice per second, ten times per second, or at a lower frequency of once every minute; or the estimation of the transmission matrix of the first fiber may be carried out when said optical fiber changes configuration, for example when a sensor such as an accelerometer measures movement of the first fiber relative to its reference configuration.

1-15. (canceled)

16. A method for measuring a transmission matrix of a first optical fiber, such as a multi-mode optical fiber, the fiber being in any configuration and guiding N eigenmodes, the optical fiber comprising a proximal section comprising a proximal end and a distal end and a distal section comprising a proximal end and a distal end, wherein the distal end of the proximal section is connected to the proximal end of the distal section by means of a fiber-to-fiber coupler, the method comprising the following steps:
separately injecting n trial fields at the distal end of the proximal section of the optical fiber,
measuring, at the proximal end of the proximal section of the optical fiber, the resulting field for each of the n injected trial fields,
estimating Hₑₛₜ, a transmission matrix expressed in the basis of the N eigenmodes of the first optical fiber.

17. The method according to claim 16, wherein the trial fields are chosen to be coherent with each other.

18. The method according to claim 16, wherein the trial fields are injected through a second optical fiber such as a multi-core fiber connected between 1 mm and 5 cm upstream from the distal end of the distal section of the first optical fiber.

19. The method according to claim 18, wherein the second optical fiber is a multi-core fiber comprising at least as many cores as there are trial fields.

20. The method according to claim 18, wherein the trial fields are the eigenmodes of the second optical fiber.

21. The method according to claim 18, wherein the trial fields injected at the distal end of the proximal section of the first optical fiber are the virtual images of the trial fields injected via the second fiber.

22. The method according to claim 16, wherein n is chosen to be greater than or equal to the largest number of mutually degenerate eigenmodes of the first optical fiber.

23. The method according to claim 16, wherein the estimation of the transmission matrix in the eigenmode basis is carried out according to a maximum likelihood method, for example using a least mean squares algorithm.

24. The method according to claim 16, comprising a preliminary step of measuring the transmission matrix of the first optical fiber in a reference configuration in a localized mode basis, then a step of changing the basis of the transmission matrix to an eigenmode basis.

25. The method according to claim 16, wherein the step of injecting the n trial fields further comprises a simultaneous injection of the n trial fields so that the relative phase between the n trial fields is measurable.

26. An optical fiber for which the transmission matrix is determined by the method according to claim 16, the optical fiber comprising a proximal section comprising a proximal end and a distal end and a distal section comprising a proximal end and a distal end, wherein the distal end of the proximal section is connected to the proximal end of the distal section by means of a fiber-to-fiber coupler, and the fiber-to-fiber coupler being configured to receive an end of a second optical fiber, such as a multi-core optical fiber.

27. The optical fiber according to claim 26, wherein the fiber-to-fiber coupler is placed between 1 mm and 5 cm from the distal end of the distal section of the first fiber.

28. The optical fiber according to claim 26, wherein the transmission matrix of the proximal section of the optical fiber is known for a reference configuration.

29. A device for endomicroscopic imaging, comprising:
a light source for emitting light beams,
a first optical fiber according to claim 11, for conveying and controlling light beams emitted by the light source, where the proximal section of the first optical fiber is in any configuration,
a detection channel intended for measuring the light signal reflected by a sample and traveling through the distal section and proximal section of the first fiber.

30. A method for endomicroscopic imaging, the method being implemented using a device according to claim 29, the method comprising the following steps:
estimating the transmission matrix of the first optical fiber in the eigenmode basis of the fiber, the proximal section of the fiber being in any configuration,
calculating a phase mask as a function of the estimated transmission matrix,
applying the phase mask sequentially to a wavefront modulator, in order to obtain a focus spot at the distal end of the fiber,
measuring the signal reflected from the focus spot by the sample and reconstructing an image of the sample pixel by pixel,
repeating the step of estimating the transmission matrix after a predetermined period of time has elapsed and/or each time the configuration of the proximal section changes substantially
